(19) United States
(12) Patent Application Publication
(10) Pub. No.: US 2022/0237601 A1
(43) Pub. Date: Jul. 28, 2022

(54) WebAuthn+JSON DLT ˜the internet of value

(71) Applicant: Michael Thomas Duffy, Austin, TX (US)

(72) Inventor: Michael Thomas Duffy, Austin, TX (US)

(21) Appl. No.: 16/974,420

(22) Filed: Jan. 27, 2021

(51) Int. Cl. G06Q 20/38; G06Q 20/32; H04W 12/06; H04L 9/32

(52) U.S. Cl. CPC G06Q 20/3829; G06Q 20/3827; G06Q 20/3223; G06Q 20/389; H04L 2209/38; H04L 9/3247; H04L 9/3239; G06Q 2220/10; H04W 12/06

(57) ABSTRACT

A system capable of securely authenticating users of a web application (or similarly distributed application). This invention, WebAuthn+, along with a simple addition to the Web Bluetooth API will completely solve the web authentication problem. And most users will be able to keep the convenience of user names and simple passwords! Simple passwords will become highly secure.

The fact that no one else has proposed this simple addition to the Web Bluetooth API, argues for the uniqueness of this invention.

In addition to secure authentication, this invention will enable the creation of Cryptographically Secure Distributed Ledgers as a “Shared Source of Truth”. Users will be able to sign a distributed ledger with one touch of their mobile device. Additions to the distributed ledger will be considered a new block, a hash code will be created and signed by the user responsible for that step in the process.

A distributed ledger that is a cryptographically secure shared source of truth will make the funds transfer process simple, secure and fast. The system will reduce the funds clearing process to a few hundred milliseconds utilizing secure cryptographic processes.

The system will have no central processing requirement and will be scalable to billions of parallel transactions per second worldwide. Financial transactions will have just four participants (and no uber blockchain storage or processes):
sender
sender's bank
recipient
recipient's bank

### REFERENCE TO RELATED APPLICATIONS

This application claims an invention which was disclosed in Provisional Application No. 62/995,443, filed Jan. 27, 2020, entitled “WebAuthn+ JSON DLT˜The Internet of Value”. The benefit under 35 USC § 119(e) of the United States provisional application is hereby claimed, and the aforementioned application is hereby incorporated herein by reference.

### FIELD OF THE INVENTION

The field of this invention relates to authentication. More particularly it relates to securing and simplifying the authentication of web applications or other applications that are accessible in a distributed fashion. Additionally, this invention makes possible the creation of Cryptographically Secure Distributed Ledgers as a “Shared Source of Truth”. These distributed ledgers will make the funds transfer process simple, secure and fast; the impact on financial services will be significant.

### BACKGROUND OF THE INVENTION

The weaknesses of user names and passwords for web authentication are well known. Various multi-factor authentication schemes have been created to address these weaknesses; however, as an FBI report that was issued in the Fall of 2019 detailed, current MFA schemes are being defeated: “the FBI offered examples of tools and techniques used to defeat MFA, including web hacks, cyberattack tools—like Muraen and NecroBrowser—and straightforward SIM swapping.” [ref: https://www.forbes.com/sites/zakdoffman/2019/10/07/fbi-issues-surprise-cyber-attack-warningurges-new-precautions]

The FBI's best advice was to, “deploy biometrics to assure user identities.” WebAuthn from the FIDO Alliance is an attempt at this scheme. WebAuthn uses out of band “authenticators” that rely on external security keys or integrated platform biometrics. This approach is problematic in that not all users have/want security keys and not all platforms have integrated biometrics. WebAuthn from the FIDO will not bring about the “passwordless future” anytime soon.

This invention, WebAuthn+, along with a simple addition to the Web Bluetooth API will completely solve the web authentication problem. And most users will be able to keep the convenience of user names and passwords! Simple passwords will become highly secure.

The fact that no one else has proposed this simple addition to the Web Bluetooth API, argues for the uniqueness of this invention.

### SUMMARY OF THE INVENTION

The essential summary is that the user has a secret key stored securely on his/her mobile device. This secret key is utilized by one or more digital credentials that have been issued to the user's mobile device in some type of secure identity proofing process. This process can be incredibly simple (e.g., email verification for a Netflix account) or highly secure (e.g., “know your customer” in establishing a banking account). A digital credential is usually associated with a specific application, but it could be associated with multiple applications and/or processes (e.g., your banking credential could be used as a proxy for government services accounts).

When a user goes to a web authentication page the Internet Browser communicates with the server over a secure channel (e.g., TLS); the Internet Browser communicates with the user's mobile device over a paired Web Bluetooth connection; the server communicates with the mobile device over a secure channel (e.g., an encrypted Firebase channel). A session UUID is shared between all three systems and when this session UUID is cryptographically signed by the user's private key (which is stored securely on the user's mobile device) and verified by the authentication server (which has a reference to the user's public key), authentication is valid.

Passing tokens between a server and mobile device is common place in web authentication schemes; tokens are most often passed by SMS and the user enters the token into the web page. Passing a session UUID to the mobile device, encrypting it with the user's private key (which is stored securely on the mobile device) and sending the encrypted value to a server which has a reference to the user and his/her public key offers enhanced security. It also provides the opportunity to store various cryptographically secure digital credentials (for various applications) on the user's mobile device. These digital credentials will not only be used for secure authentication but also for financial transfers and for signing “Cryptographically Secure JSON Distributed Ledgers” (JSON DLT) which will be the foundation of the Internet of Value (two additional claims are being made for these processes).

The Internet of Value has the potential to ignite a worldwide renaissance by providing, “ubiquitous access to efficient financial systems and the ability to transact with anyone in the world.” [ref: https://www.w3.org/WebCommerce/IG/wiki/Internet_of_Value_Manifesto]

What we are proposing for “Cryptographically Secure JSON Distributed Ledgers” (JSON DLT) is very different from the Bitcoin/Blockchain hype.

In the invention that we are proposing we are not attempting to create a comprehensive ledger of all transactions or a new cryptocurrency, instead we are creating cryptographically secure distributed ledgers for specific atomic business processes where all the private participants have secure digital credentials that have been verified. Anonymity is NOT a positive feature for legitimate business transactions. A comprehensive distributed database is NOT necessary.

The focus on a specific atomic business process means that there will be a limitation in scope for the participants. While it would be possible to create a blockchain for ALL automobile ownership or ALL home ownership, when I buy a car or a home I really only care about my purchase (and my privacy); having a cryptographically secure distributed ledger with digital signatures of all the participants for my purchase will meet my needs.

Think of a cryptographically secure distributed ledger as a blockchain with a specific limited scope. Each section of the distributed ledger will have a cryptographically signed hash code that will chain it to the previous block. Each link in the chain will be identifiable through a participant's cryptographically secure digital credential. All participants will have a copy of the distributed ledger, but an uber blockchain will not be used as a distributed database.

A distributed ledger that is a cryptographically secure shared source of truth will make the funds transfer process simple, secure and fast. The system will reduce the funds clearing process to a few hundred milliseconds utilizing secure cryptographic processes.

WebAuthn+ Distributed Ledger Technology will be the foundation of the ultimate FinTech system. Once a user's digital financial credentials can be trusted the process becomes very efficient.

The system will have no central processing requirement and will be scalable to billions of parallel transactions per second worldwide. Financial transactions will have just four participants (and no uber blockchain storage or processes):
sender
sender's bank
recipient
recipient's bank

### BRIEF DESCRIPTION OF THE DRAWINGS

FIG. 1 shows the WebAuth+ Process With Fully Functional Web Bluetooth
1. The user goes to the web application's “Sign On” page.
2. The generated Session UUID, the Credential Type and the User Identifier (e.g., email) are sent from the Internet Browser to the server over encrypted transport. The server returns a visual Authentication Code (e.g., “WHSL LRTU FLVM”) to the browser.
3. The web application's domain name, the generated Session UUID, the Credential Type, the User Identifier and the visual Authentication Code are sent to the user's smart phone through an encrypted Firebase channel from the server or some other encrypted transport from the server.
4. The generated Session UUID and the web application's domain name (prevents phishing) are sent to the user's smart phone directly from the web browser over a local Web Bluetooth connection; these values are confirmed against values sent from the server. If confirmation fails, the authentication process terminates. The value of the web application's domain name will be sent from the Internet browser's application context, not as a parameter from the JavaScript which could be easily modified in a Phishing attack. Using Web Bluetooth to confirm the Domain Name solves one of the fundamental problems of secure web authentication: insure the user is on the right web page; e.g., “www.chase.com” not “www.chaze.com” (this completely stops phishing scams).
5. On a set interval (5 seconds), the browser pings the server; the server either responds with, “Not Authenticated”, or with a valid Authentication UUID (if step 7 has been completed). A secondary implementation that utilizes Web Sockets is an alternate approach.
6. If the values from the server and the web browser are a valid match, the user is notified of the sign on request. The user touches the sign on button on his/her smart phone which initiates step 7.
7. The Session UUID is signed with the user's private key (which is stored securely on the user's smart phone) and the signed value is sent to the server which has a record of the user's public key. If the signature is valid an authenticated session is established for the user.
8. With an authenticated session, the user now has secure access to the web application. The simplicity of this authentication process is that the user goes to a web page, receives a notification on his/her smart phone and simply touches the sign on button.

FIG. 2 shows the WebAuth+ Process When Web Bluetooth is Absent

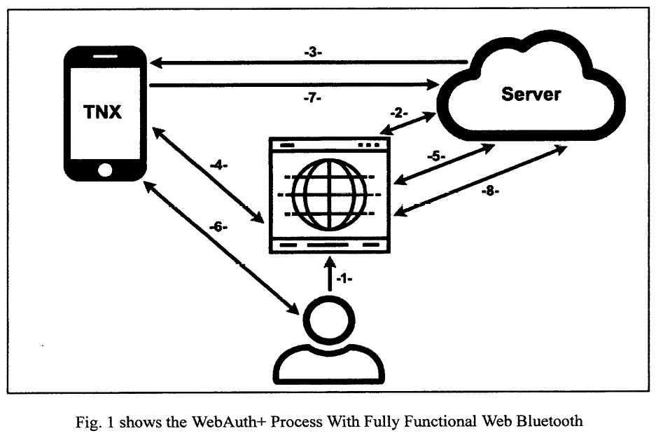

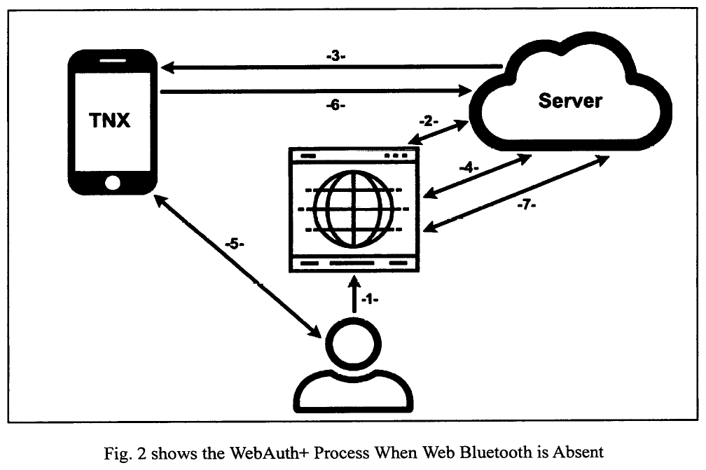

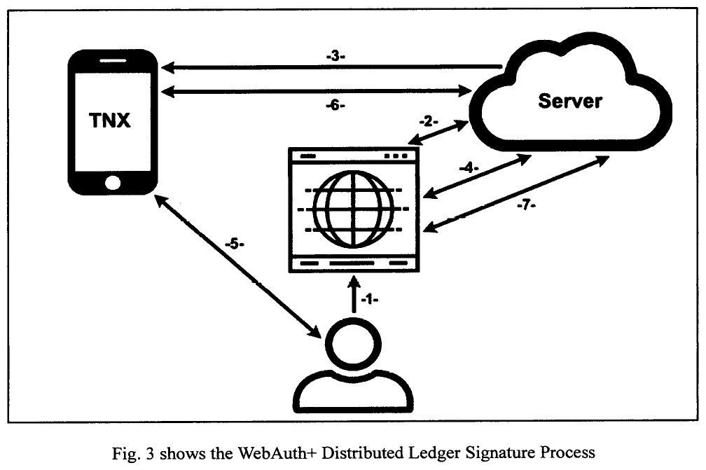

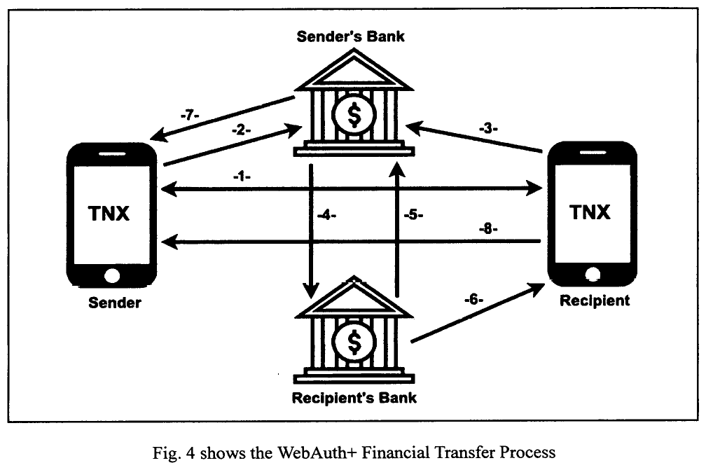

Not all computers have fully functional Web Bluetooth. The WebAuthn+ process will function even when Web Bluetooth is absent.
1. The user goes to the web application's “Sign On” page.
2. The generated Session UUID, the Credential Type and the User Identifier (e.g., email) are sent from the Internet Browser to the server over encrypted transport. The server returns a visual Authentication Code (e.g., “WHSL LRTU FLVM”) to the browser.
3. The web application's domain name, the generated Session UUID, the Credential Type, the User Identifier and the visual Authentication Code are sent to the user's smart phone through an encrypted Firebase channel from the server or some other encrypted transport from the server.
4. On a set interval (5 seconds), the browser pings the server; the server either responds with, “Not Authenticated”, or with a valid Authentication UUID (if step 6 has been completed). A secondary implementation that utilizes Web Sockets is an alternate approach.
5. The user is notified of the sign on request. The user checks the domain name which appears on both the sign on web page (the address bar URI display comes only from the browser context and cannot be spoofed) and on the user's smart phone (with a value that has been sent securely from the server); if they match, the user touches the sign on button on his/her smart phone which initiates step 6.
6. The Session UUID is signed with the user's private key (which is stored securely on the user's smart phone) and the signed value is sent to the server which has a record of the user's public key. If the signature is valid an authenticated session is established for the user.
7. With an authenticated session, the user now has secure access to the web application. The simplicity of this authentication process is that the user goes to a web page, receives a notification on his/her smart phone and simply touches the sign on button.

FIG. 3 shows the WebAuth+ Distributed Ledger Signature Process

In this process the web browser or some other display application could exist on the user's smart phone or on another device.
1. A user authenticated through the WebAuthn+ process goes to the web application's “Distributed Ledger Page” page. This page could be an immutable contract with just a display of text or have editable form fields. When the user is satisfied with the values he/she clicks a signature button.
2. The distributed ledger values, the generated Session UUID, the Credential Type and the User Identifier (e.g., email) are sent from the Internet Browser to the server over encrypted transport. The server returns a visual Authentication Code (e.g., “WHSL LRTU FLVM”) to the browser.
3. The web application's domain name, the generated Session UUID, the Credential Type, the User Identifier and the visual Authentication Code are sent to the user's smart phone through an encrypted Firebase channel or some other encrypted transport from the server. At this point the distributed ledger values are not sent; this part of the process is just a notification of a signature request.
4. On a set interval (5 seconds), the browser pings the server; the server either responds with, “Not Signed”, or with a valid Signature UUID (if step 6 has been completed). A secondary implementation that utilizes Web Sockets is an alternate approach.
5. The user is notified of the signature request. The user touches the signature button on his/her smart phone which initiates step 6.
6. The Session UUID is signed with the user's private key (which is stored securely on the user's smart phone) and the signed value is sent to the server which has a record of the user's public key. If the signature is valid the server returns the values of the distributed ledger to the user's smart phone. A hash value is calculated which is a cryptographic representation of the values in the distributed ledger. This value is signed by the user's private key and returned to the server.
7. The server calculates the hash value and compares it to the value sent from the user's smart phone. If the values are a match the server checks the signature of the hash value. If the signature is valid the process is complete for now. Additional values could be added to the distributed ledger and signed by other users. Each signature block would have a calculated has code that would “chain” that block to all previous blocks creating a cryptographically secure shared source of truth. The simplicity of this signature process is that the user goes to a web page, reviews the values of the distributed ledger, receives a notification on his/her smart phone and simply touches the signature button.

FIG. 4 shows the WebAuth+ Financial Transfer Process
1. The process begins with either the recipient sending the sender a signed distributed ledger with a request funds request (e.g., a seller requests funds from buyer) or the sender sending the recipient a signed distributed ledger with a send funds request (e.g., someone sends money to a friend or relative). In the first case the sender will include his/her financial information, sign the funds request and return it to the sender.
2. The sender sends the signed distributed ledger to his/her bank or financial institution.
3. The recipient has received the sender's financial information in step 1; the recipient includes his/her financial information, signs the distributed ledger and sends it to the sender's bank or financial institution.
4. The sender's bank adds pertinent information to the distributed ledger, signs it and sends it to the recipient's bank.
5. The recipient's bank accepts the transfer, adds pertinent information to the distributed ledger, signs it and sends it to the sender's bank.
6. The recipient's bank sends a notification to the recipient that funds have been transferred.
7. The sender's bank sends a notification to the sender that funds have been transferred.
8. The recipient sends and acknowledgment to the sender that funds have been received.

### DETAILED DESCRIPTION OF THE INVENTION

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

I am filing this application pro se. I assume this is the section that provides the details for a person having ordinary skill in the art (PHOSITA) to be able to be able to create the invention.

The key concept to understand is that in order to prevent phishing scams there must be an “out of band” (i.e., outside the Internet browser) confirmation that the user is on the right web page; e.g., “www.chase.com” not “www.chaze.com”. This is accomplished by having the domain name sent to the user's smart phone over a close proximity Web Bluetooth connection. This connection is validated by a session UUID sent to the smart phone by both the browser and the application server. The value of the web application's domain name is sent from the Internet browser's application context, not as a parameter from the JavaScript which could be easily modified in a Phishing attack.

This change will require a slight addition to the Web Bluetooth API. The fact that no one else has proposed this simple addition to the Web Bluetooth API, argues for the uniqueness of this invention.

In order for a person having ordinary skill in the art (PHOSITA) to be able to be able to create the invention, the following information about the cryptographic processes is essential.

In the explanation that follows, the named cryptographic algorithms are meant to be descriptive, not proscriptive. Algorithm versions are constantly improving; there may have been updates since the algorithms in this exposition were first chosen.

Cryptographic Overview

The goal of the WebAuthn+ open source project is to implement the highest standards in Real World Crypto, both in the selection of algorithms and in social processes.

Creating and Distributing the System Level Public Key

In every system that depends on cryptographic processes, one of the most important tasks is the creation, security and distribution of keys.

In the WebAuthn+ open source project there is an initialization class, InitializeB_Keys.java, that creates the system level key pair.

KeyPairGenerator keyPairGenerator=KeyPairGenerator.getInstance(CryptoUtilities.KEY_FACTORY_ALGORITIIM);

keyPairGenerator.initialize(CryptotUtilities.PUBLIC_KEY_MODULUS);

KeyPair pair=keyPairGenerator.generateKeyPair( );

The “KEY_FACTORY_ALGORITHM” is RSA. The “PUBLIC_KEY_MODULUS” is 4,096 (which is significantly large).

In the prototype application both the public key and the private key are stored in the database on the authentication server. In the code comments we note: “This is NOT a good idea for a production level application. Some good suggestions for storing the private key can be found here: https://security.stackexchange.com/questions/12332/where-to-store-a-server-side-encryption-key”

For the distribution of the system level public key we depend upon the security processes of the Google Play Store and the Apple App Store. The system level public key is embedded within the code of the mobile applications. These distribution systems for mobile applications have security requirements for code signing and authentication to the developer's account.

If these processes can be compromised by external bad actors or internal bad actors within Google or Apple, the system could be disrupted but not compromised (no illegitimate access through WebAuthn+). If a faulty app or a bad public key was distributed to users, the authentication system would fail but not allow access; the system can only be compromised if a bad actor gains access to the system level private key.

If the private key is compromised, the security solution is to update the public/private key pair by creating a new version of the mobile app with a new public key and requiring all users to update to the new version.

Creating the User

When a user downloads and installs the WebAuthn+ mobile app, the first screen the user sees is the password creation screen. The initial rule is that the password must be at least eight characters, numbers or values. Requirements can be set in code on password length and complexity.

Important note: We do not use simple password based encryption to secure data on the user's smart phone. We will cover the issue of securing data on a smart phone later in a section below.

The user creates and confirms his/her password and is then taken to the Profile screen. The password is held in memory for now.

Only the “Screen Name” and “Contact Email Address” are required in the reference implementation.

When the user clicks “Save Profile” a UUID is created for the user and this value, along with the profile information, is sent to the WebAuthn+ application server.

Communicating Between the Mobile App and the Application Server

Sending data from the WebAuthn+ mobile app to the WebAuthn+ application server follows a standard pattern based on TLS.

For every transmittal, a 256 bit AES symmetric key is generated within the Android code using the KeyGenerator class. This key will be used to encrypt the data we are transferring to the WebAuthn+ application server; we will refer to this key as the “transfer key”.

A Cipher is created using the RSA algorithm and “PKCS1Padding”. This cipher is initialized using the system level public key which has been distributed with the WebAuthn+ mobile app. The cipher is used to encrypt the “transfer key”.

The user profile data is formatted into a text block of comma separated name/value pairs. We will refer to this data as the “transfer data”.

A Cipher is created using the AES_256 algorithm and “PKCS5Padding”. This cipher is initialized using the “transfer key” and an initialization vector of 16 bytes. The cipher is used to encrypt the “transfer data”.

We could in theory just use the cipher created using the RSA algorithm and “PKCS1Padding” to encrypt the transfer data and skip the creation of the “transfer key”; however, encryption using an RSA based cipher is considered inefficient and is limited to a fairly small block size of data. So we only use the RSA cipher to encrypt the “transfer key” which is a 256 bit AES symmetric key that is very efficient and can encrypt large blocks of data.

A “Message Authentication Code” (MAC) is created for the encrypted “transfer data” using the “transfer key”. The MAC algorithm is HmacSHA256. The MAC will insure message integrity.

A set of URL parameters (name value pairs) is created; this is the information that will be sent to the application server:
PUBLIC_KEY_UUID
TRANSFER_KEY_ENCRYPTED
TRANSFER_DATA_ENCRYPTED
TRANSFER_DATA_MAC

The “CREATE_USER_URL” is contained within the WebAuthn+ mobile app as a constant; the URL is a call to an action class on the WebAuthn+ application server.

When the URL parameters are received on the WebAuthn+ application server the private key associated with the PUBLIC_KEY_UUID is used to decrypt the TRANSFER_KEY_ENCRYPTED. The “transfer key” is used to recreate the MAC of the TRANSFER_DATA_ENCRYPTED. If this recreated MAC equals the TRANSFER_DATA_MAC, all is well and we proceed to decrypt the TRANSFER_DATA_ENCRYPTED using the “transfer key” and create the user within the data structures of the WebAuthn+ application server.

We need an unambiguous reference to the PUBLIC_KEY_UUID; we cannot encrypt this value for transit because we would not know which key should be used for the decryption. The worst case scenario is that a bad actor modifies the URL parameters in transit and the process fails (the process cannot be compromised by a bad actor; it can only be disrupted). For similar reasons, we do not encrypt the TRANSFER_DATA_MAC.

A response string (e.g., USER_SUCCESSFULLY_CREATED or USER_ALREADY_EXISTS or MESSAGE_INTEGRITY_COMPROMISED or PROBLEM_WITH_AUTHENTICATION_SERVER) is encrypted with the “transfer key” and returned to the WebAuthn+ mobile app along with a MAC to insure message integrity.

When we are sending an HTTP response from the WebAuthn+ application server to the WebAuthn+ mobile app, as in the example above, we can just use the “transfer key” which is already known by the WebAuthn+ mobile app.

When communicating directly from the WebAuthn+ application server to the WebAuthn+ mobile app, as in the example below, we communicate from the application server to the user's smart phone through an encrypted Firebase channel. These messages are short enough that they can be encrypted with the user's public key which is stored in the data structures of the WebAuthn+ application server. These messages can only be decrypted with user's private key which is, “stored securely on their smart phone.”

Securing Data on a Smart Phone

What do you mean, “stored securely on their smart phone”? Is that a joke? We all know from the Apple v FBI encounter that anything on your smart phone can be decrypted by anyone with marginal computer skills. It is incredibly easy to do.

Well . . . it is not easy to do if the encryption process is done in a sensible manner (send the following architectural overview to your friends at Apple).

When a user downloads and activates the TNX WebAuthn+ mobile app from the Apple App Store or from the Google Play Store, in the installation process the mobile app generates a 4,096 bit public/private key pair in less than ten seconds (on a “good” phone). A 4,096 bit key pair is very large and highly secure (double the traditional recommendation by RSA Laboratories).

The public key is uploaded to the mobile app provider's (e.g., your bank's) data structures. The private key never leaves your smart phone. The private key is stored on your smart phone in an encrypted state.

In order to protect the private key and other data within the TNX WebAuthn+ mobile app, access to the app is protected by a password and that password is used to generate a secret key using the PBKDF2WithHmacSHA256 algorithm. The two most important inputs into this algorithm are the password itself and the iteration count. The more complex the password and the higher the iteration count the higher the computational cost for anyone trying to crack the secret key. We also use a UUID salt value as an input in generating the secret key; this guarantees uniqueness.

The reference implementation uses an iteration count of 262,144. The iteration penalty is imposed every time a user enters his/her password and activates the TNX WebAuthn+ mobile app. On a good phone the time penalty is about 2.5 seconds (about the limit for a “bad” user experience).

If the user chooses a password that is ridiculously easy to guess (e.g., “password”, “123”, “asdf”) then the quality of the algorithm and the iteration count do not make a difference. The system is highly vulnerable.

On most mobile app keyboards there are 82 characters to choose from (26 lower case, 26 uppercase, 10 numeric and 20 symbols). If a user creates a password with twelve characters there are 82 to the 12th power possible permutations to consider when cracking the secret key generated from the password:

82\hat{ }12=92,420,056,270,299,898,187,776

That is 92 sextillion and change. If you randomly go through half the possibilities, you have a about a 64% chance of hitting the right password. How long would that take if each guess took 1 second to compute on a very fast computer and you had an array of one million computers?

92,420,056,270,299,898,187,776/2 (half the possibilities for a 64% probability)/1 million computers/60 seconds in a minute/60 minutes in an hour/24 hours in a day/365 days in a year=1,465,310,380 years

That's 1.465 billion years; the age of the Earth is estimated at 4.543 billion years. In cryptography, the key is to use algorithms that require a significant time penalty to defeat.

Assume that a user chooses a eight character password. The number of possibilities is 82\hat{ }8=2,044,140,858,654,976 and the time calculation goes to 32.4 years; not great but maybe “good enough”.

Assume that you are trying to protect some system like your phone with a four digit PIN. Well, that is only 10,000 possible combinations and the system could be cracked in a matter of seconds. Assuming that the iPhone was protected by a PIN or a weak password, it really was no big deal that the FBI was able to crack the system.

In the WebAuthn+ process, even though the secret key that is generated by the PBKDF2WithHmacSHA256 algorithm (using the password and iteration count) could be used to encrypt data on the user's smart phone, if the phone was lost or stolen a bad actor could do a brute-force attack and “eventually” decrypt the data.

Instead, the PBKDF2WithHmacSHA256 key is used to generate an obfuscated identifier that is associated with the user but cannot be used to identify the user, for example:

### 2E988595485874A71449546BB49A7AFC9B603ED5EFFD7A5DAC9B8B333A345B78

When a user enter his/her password in the TNX WebAuthn+ mobile app this obfuscated identifier is generated and sent to the server.

In order to attain a high level of security an AES-256 symmetric key is also created when the TNX WebAuthn+ mobile app is installed. This key is used to encrypt/decrypt data on the smart phone. This AES-256 key is encrypted with the PBKDF2WithHmacSHA256 key and stored off the smart phone in the application provider's data structures, associated with the obfuscated identifier.

When a user enter his/her password in the TNX WebAuthn+ mobile app and sends the obfuscated identifier to the server, the encrypted AES-256 key is returned and decrypted using the PBKDF2WithHmacSHA256 key. This AES-256 key is then used to encrypt/decrypt data on the smart phone.

When a user enter his/her password in the TNX WebAuthn+ mobile app, after a configurable number of failed attempts (bad password entries) the mobile app locks and the assistance of a personal banker (or a team member from corporate security, etc.) is required to reconfigure the app. Don't forget your password unless you want to see your personal banker or a team member from corporate security, etc.

Because after a configurable number of failed attempts (bad password entries) the mobile app locks, it is impossible to retrieve the decrypt key and attack WebAuthn+ through a brute-force attack.

It is important not to associate the user's encrypted AES-256 key with the user in the server data structures. Associating the user's symmetric key with an obfuscated identifier and not the user's account limit's the possibility that a bad actor within the mobile app provider's organization could gain access to a user's symmetric key, steal the user's smart phone and gain access to the user's accounts.

The only way to secure data on a smart phone is to encrypt the data with a key that is stored off the device, delete the key from the smart phone when it is not needed and load the key in a secure process when it is needed. Our process takes just a few seconds and is within the boundaries of being user friendly.

So if your smart phone is lost or stolen, a bad actor cannot sign on to your TNX WebAuthn+ mobile app; and if a bad actor can programmatically gain root access to your smart phone and read the stored data, the important data (i.e., your private key) is securely encrypted.

Even if a government agency ordered a service provider to decrypt the data on a user's smart phone, the service provider would not be able to comply.

Why don't we just use the security key within the Trusted Platform Module provide by the phone manufactures? There are both social reasons and technical reasons. Big corporations have now proven that they cannot be trusted with our personal data AND they cannot be trusted not to collude with evil governments. There are also numerous technical reasons not to trust TPM (easily found by doing a Google search on “Can TPM be hacked?”).

Secure Authentication

If a user has a secure private key on his/her smart phone and if there is a secure association on the WebAuthn+ application server between the user identifier (email address) and the user's public key, authentication can become simple and secure.

Communication between the browser and the WebAuthn+ application server is done securely over TLS.

Communication between the WebAuthn+ mobile app to the WebAuthn+ application eerier is secure (details above).

Communication between the WebAuthn+ mobile app and the web browser will be more secure when Session Specific Pairing is implemented (details below).

The steps in the process are detailed above in BRIEF DESCRIPTION OF THE DRAWINGS˜FIG. 1 shows the WebAuth+ process with fully functional Web Bluetooth.

For step four to work in a secure manner the host's domain name needs to be sent from the browser application code to the Bluetooth Gatt Server running on the user's mobile device. Application level (from within the browser code) messaging from the browser to the smart phone over Bluetooth is not yet supported by the Web Bluetooth API. The prototype uses a direct Java Script method call:

domainNameCharacteristic.writeValue(textEncoder.encode(domainName));

With this direct java Script call, the domain name could be spoofed in a sophisticated man in the middle attack. All that is necessary to make this process completely secure is a simple addition to the Web Bluetooth API (or through a direct modification of the browser code without worrying about W3C niceties). A method needs to be added and this method needs to be run from within the browser context. The domain name needs to be sent by the browser, not as a parameter in the Java Script (which could be easily modified):

writeDomainNameCharacteristic( )

This is the key problem that needs to be solved for web authentication to be secure: a secure “out of band confirmation” that the user is on the “right” web page; e.g., “www.chase.com” not “www.chaze.com” (this completely stops phishing scams). The solution is a simple addition to the Web Bluetooth API or direct change of the browser code.

Once this change is made, excluding attacks against the operating system and malware that mimics or compromises a true application, there is only one threat vector: If a bad actor “looks over your shoulder”, steals your password, then steals your smart phone, and defeats the fingerprint reader (or other security) before you can report your smart phone lost or stolen . . . then the bad actor can access your account.

Session Specific Pairing

The pairing process currently specified by the Web Bluetooth API is not user friendly and not highly secure. “Session Specific Pairing” would be a great improvement.

Currently, JavaScript code in the web browser makes a request for a Bluetooth device advertising a specific service. Any device with the service UUID within sixty meters will show up in the pairing screen.

The user must select from potentially multiple devices in the pairing list. The reason for this manual selection has to do with security. The creators of the Web Bluetooth API did not want a web application to pair with just any Bluetooth device that happened to be close by and advertising a specific service; they wanted human intervention.

However, it is incredibly annoying to have to manually pair your mobile phone whenever you sign on, especially when your phone is the only device in the list.

The process would be far more efficient and secure if a session UUID was added to the filters for the Bluetooth.requestDevice( ) JavaScript method. This session UUID would be sent to the mobile device by the browser and checked against the session UUID sent to the mobile device from the server. With this change, Web Bluetooth pairing could become automatic and more secure (no chance of the user selecting the wrong device).

In the Java Script, we would just add a sessionUuid to the services attributes:

let device=await navigator.bluetooth.requestDevice({filters: [{services: [serviceUuid, sessionUuid]}]});

A “message” attribute could also be added to the filters; e.g., “{message: [‘Activate your WebAuthn+ mobile app.’]}”

Once the app is activated it will start advertising with the service UUID and the session UUID; it will be picked up by the browser and automatically paired. Life will be beautiful.

Establishing a Trusted System˜The Nirvana of Simple Passwords

Once the user successfully signs on through WebAuthn+, he/she can designate the system as a “trusted system”. In the future, the user can authenticate with a user name and supple password.

The password can be incredibly simple because the value that the user enters is combined with a UUID salt value that is stored on the user's system as a cookie (hence, the system needs to be secure). The values are used to generate a cryptographic hash using the Stanford JavaScript Cryptography Library.
var out=sjcl.misc.pbkdf2(password, sjclSalt, sjclIterationCount, sjclLength);
var passwordHash=sjcl.codec.hex.fromBits(out).toUpperCase( );
console.log(“passwordHash:”+passwordHash); //TODO: remove

A simple user password of “asd” becomes “7C3249A2415F53FC1A8A150C60C9347CBC14AE0C62C7C5C73FF4BC45A15ECFCA”; this value is essentially a generated password and is sent to the server over encrypted HTTPS. The value is hashed once again on the server with the Argon2id hashing algorithm (most secure) and stored on the server as a set of Argon2id parameters:

‘$argon2id$v=19$m=1048576,t=4,p=8$HQiUtZvto2icGsXVTF/BJw$emWzw24cLFh trind8WUhZDyjRJHCg1C0J9542yTPCiACE’

Whenever the user signs on, the hash values are recalculated and compared with the stored hash value. Without access to the user's physical system and knowledge of the user's password, it is impossible for a bad actor to sign on, even if there was a complete breach of the server data. The user can use the same simple password across multiple sites because each time it will be combined with a different salt value and will be stored on different servers as a completely different hash value.

A cookie with a password on a trusted system is actually more secure than a digital certificate on a “trusted system”. With a digital certificate a bad actor just needs to access the system, either physical access or through malware. When a cookie and a password are required a bad actor would need both. Essentially, the cookie turns your trusted system into a “something you have” authentication factor; similar to the Windows 10 PIN authentication.

Also, the user can always reset his/her own password. There is no need to call tech support.

Everyone assumed that user names and passwords had to be eliminated in order to solve the authentication problem. The paradox of the WebAuthn+ solution is that most users will be able to keep their user names and passwords, and passwords can become even simpler.

WebAuthn+ provides an open source reference implementation.

A system is secure if the plans for the system are public, and the bad actors can still not break in.

Cryptographically Secure JSON Distributed Ledgers

As stated in the summary, what we are proposing for “Cryptographically Secure JSON Distributed Ledgers” (JSON DLT) is very different from the Bitcoin/Blockchain hype. What we are proposing is creating a private a cryptographically secure shared source of truth.

In it's simplest implementation, a business process represented by elements in an HTML web page (e.g., a contract) could be sent to a user's smart phone where a hash value of all the elements would be calculated; the hash value would be signed by the user's private key. If this private key has a secure association with the user and the user's public key on an application server, the signature provides immutable and irrefutable proof that the user associated with that private key signed the elements. This process is detailed in FIG. 3 above.

With trusted digital credentials that associate a user to a private key on his/her mobile device, financial transfers become a simple process of creating a “Cryptographically Secure JSON Distributed Ledgers” that is signed by the user, his/her bank, the recipient and his/her bank. This process is detailed in FIG. 4 above.

Transformation of Business Processes and Financial Services

In the very near future, all business processes and agreements (including all financial transactions) will be confirmed by a cryptographic signature of a JSON Distributed Ledger (structured data of the agreement details, test image below). The signature will be implemented by a simple touch on your smart phone. Business process management will be transformed. Your smart phone will enable the creation of an inviolable business record. Complex records among multiple participants will have cryptographically secure attestations.

Cryptographically secure distributed ledgers will truly become a transformational technology that will exceed all initial expectations. It is possible to create a cryptographically secure shared source of truth where all participants are trusted, privacy is maintained and all participants are instantaneously notified of changes.

All financial services will be transacted through digital credentials on your smart phone. If your financial institution verifies you, everyone will be able to trust your digital credentials. This extension of trust will eliminate fraudulent financial transactions and uplift the Third World by providing secure and efficient financial services for everyone on the planet.

This technology will generate great benefits for all businesses, from startups to multi-national corporations to impoverished villagers in the third world. Cryptographically Secure JSON Distributed Ledgers will become the standard format for secure processes/transactions. Some have estimated that the resulting economic efficiencies (by reducing time, costs and risk) will be “measured in trillions of dollars.”

A point of emphasis, these cryptographically secure distributed ledgers have nothing to do with crypto-currencies, blockchains or distributed data structures; this has nothing to do with the blockchain hype (a problematic technology that is going nowhere). This has everything to do with secure authentication and transforming business process management.

This invention will also usher in the age of practical artificial intelligence (AI based on lots of structured decision making data, harvested for optimal decisions).

Again, the cryptographic signature of a distributed ledger will be implemented by a simple touch on your smart phone.

The Concept of Identity

The old concepts of digital identity will pass away.

Conceptually, the most significant aspect of our system is that your identity is not determined by a collection of attributes; your identity is determined by a cryptographically secure digital credential that associates “you” to a public key. For each specific context, the essence of “you” is determined by an institutional validation (the identity proofing process when the secure digital credential is issued).

If your bank or corporation validates you and issues you a digital credential, your identity does not matter, all that matters is that you are the only person who can utilize that credential.

Think of the past when the king's seal represented a stamp of approval; your identity did not matter, all that mattered was the validity of the king's seal and that you were the rightful holder of the credential. In the age of technology it is possible to create a “valid seal” with a secure private key on a smart phone.

A cryptographically secure digital credential is an inviolable proxy to the valid institutional process that was used for identity proofing. Once the institution determines that “you are you”, the digital credential can be used to verify that institutional validation.

What is claimed:

1. A system capable of securely authenticating users of a web application (or similarly distributed application), comprising:
an authentication server configured to store user credentials in various formats and various levels of detail, most significantly the user credential will contain the user's public key; the authentication server will be capable of validating cryptographic signatures and communicating with an Internet Browser (or similarly distributed application) over a secure channel and with the user's mobile device over a secure channel;
a web application running in an Internet Browser (or similarly distributed application) capable of communicating with an authentication server over a secure channel and a user's local mobile device over a secure channel;
a user's local mobile device capable of communicating with an authentication server over a secure channel and with an Internet Browser (or similarly distributed application) over a secure channel;
wherein the authentication server is further configured to generate a session UUID (or similar identifier) that is shared with the Internet Browser (or similarly distributed application) and with the user's mobile device;
wherein the Internet Browser (or similarly distributed application) is further configured to communicate the web application's domain name (or similar identifier) to the user's mobile device from the application context of the Internet Browser (or similarly distributed application), not from a code run time context that can be modified by users;
wherein the user's mobile device is further configured to store the user's private key, sign the session UUID (or similar identifier) received from the authentication server and return the signed value to the authentication server

2. The authentication system of claim 1, wherein:
the Internet Browser (or similarly distributed application) is not capable of communicating with the user's local mobile device over a secure channel;
wherein the Internet Browser (or similarly distributed application) displays the web application's domain name (or similar identifier) in the address bar (or similar display) and this display is unalterable by the code run time context;
wherein the authentication server communicates the web application's domain name (or similar identifier) to the user's mobile device for display and with an admonition that this value must be checked against the value displayed by the Internet browser;

3. The authentication system of claim 1, wherein:
the Internet Browser (or similarly distributed application) displays the values of a distributed ledger or legal contract or bill of sale or other text values;
wherein these values are communicated to the authentication server and relayed to the mobile device of an authenticated user
wherein an application running on the mobile device calculates a hash code of the values sent from the authentication server, sings the hash code with the user's private key and communicates the hash code and signature to the authentication server;
wherein the authentication server verifies the hash code and signature and stores the values for future use, possibly by adding additional values and “chaining” additional hash codes and signature;

4. The authentication system of claim 1, wherein:
the mobile device of a funds sender and the mobile device of a funds recipient both interact with an authentication server at the sender's bank or financial institution;
wherein the mobile device of a funds recipient can interact with an authentication server at the recipient's bank or financial institution;
wherein the sender's mobile device is capable of sending a message with financial details (or a reference code that links to the financial details) to the recipients mobile device and to the authentication server at the sender's bank or financial institution; a hash code of the financial details is calculated and signed with the sender's private key;
wherein the recipient's mobile device is capable of appending financial details to the message from the sender, calculating a hash code of the combined message, signing the hash code and sending it to the sender's bank or financial institution;
where as the authentication server of the sender's bank or financial institution is capable of communicating with the authentication server of the recipient's bank or financial institution;
where as the authentication server of the sender's bank or financial institution and the authentication server of the recipient's bank or financial institution are both capable of calculating a hash code of the messages and verifying the signatures from the sender's mobile device and the recipient's mobile device and determining that the transfer is valid;

5. The authentication system of claim 1, wherein:
once the user is securely authenticated the user is able to perform future authentications with simple user names and passwords;
where in an application running in the Internet Browser (or similarly distributed application) is able to store a value (e.g., a UUID Salt) and combine this value with the simple password in a one way cryptographic hash algorithm that guarantees a unique and repeatable result;
wherein the result of the cryptographic hash algorithm is sent to the authentication server, hashed again, and stored on the server as a hashed value;
wherein, when the user performs future authentications, the hash value sent to the authentication server is hashed again and this value is compared to the stored value; if they match, the user is authenticated;
